(19) United States
(12) Patent Application Publication
(10) Pub. No.: US 2008/0017396 A1
(43) Pub. Date: Jan. 24, 2008

(54) Hand-held machine tool with vibration-reducing device

(76) Inventors: Ferdinand Kristen, Gilching (DE); Roland Meuer, Ettringen (DE); Ruediger Schulz, Klingenberg (DE)

Correspondence Address: ABELMAN, FRAYNE & SCHWAB, 666 THIRD AVENUE, 10TH FLOOR, NEW YORK, NY, 10017, US

(21) Appl. No.: 11/811,332

(22) Filed: Jun. 7, 2007

(30) Foreign Application Priority Data
Jun. 9, 2006 (DE) 10 2006 000 287.3

(51) Int. Cl. B25D 17/00

(52) U.S. Cl. 173/162.2

(57) ABSTRACT

A hand-held machine tool (2) has a main housing (6) at which vibrations are generated during operation, a handle housing (12) that is held at the main housing (6) with the intermediary of a vibration-reducing device (14), and an adjusting arrangement (22) which has an adjusting device on the main housing side which can be adjusted between at least two positions and an adjusting device on the handle housing side which can be adjusted between at least two positions and which is mechanically connected to the adjusting device (26) on the main housing side by an adjusting connection (26). The adjusting connection (26) has a flexible vibration-reducing portion (36) between the handle housing (12) and the main housing (6).

### BACKGROUND OF THE INVENTION

1. Field of the Invention

The present invention is directed to a hand-held machine tool, particularly in the form of an electric multipurpose hammer which can be used selectively as a drill hammer or chisel hammer, having a main housing at which vibrations are generated during operation. More specifically, the present invention is a hand-held machine tool which can be used selectively as a drill hammer or chisel hammer, and includes an adjusting arrangement for selectively locking and unlocking the tool while operating in a chisel mode, as well as preventing locking while operating in a drill mode of operation.

2. Description of the Prior Art

An electric multipurpose hammer that can be used as a drill hammer or as a chisel hammer is known from DE 100 34 768 A1. Further, a locking device by which a pawl of a motor switch can be locked in chisel operation is provided at a handle. In drill mode, the locking device, which is actuated by a linkage by a mode switch that is held at the main housing, is shifted to a disabled position.

The known hand-held machine tool has the disadvantage that the linkage, which in this case functions as an adjusting connection, transmits vibrations from the main housing to the handle housing during operation. Further, assembly of the linkage is relatively time-consuming and increases production costs.

### SUMMARY OF THE INVENTION

It is the object of the present invention to overcome the above-mentioned disadvantages in a hand-held machine tool of the generic type and to minimize additional transmission of vibrations from the main housing to the handle housing via the adjusting connection.

According to the invention, the adjusting connection has a flexible vibration-reducing portion between the handle housing and the main housing. By means of this flexible vibration-reducing portion, the portion of the adjusting arrangement on the handle housing side is insulated from the portion on the main housing side with respect to vibrations so that no noticeable vibrations are transmitted to the handle housing via the adjusting arrangement.

In a particularly preferred embodiment form, the flexible vibration-reducing portion is formed by a bowden cable. This makes it possible for particularly high adjusting forces to be transmitted from the main housing to the handle housing, and vice versa, while achieving flexibility at the same time. In addition, a bowden cable of this type is particularly economical and can be assembled easily.

In an advantageous manner, the hand-held machine tool is an electric multipurpose hammer which can be switched between drill mode and chisel mode. The adjusting arrangement is formed by a locking arrangement, which can be switched depending on function and by means of which a pawl of a motor switch can be fixed in position, for example, locked in a “continuously on” position. In this way, a multipurpose hammer can be provided whose switch pawl can be locked in the chisel mode, while locking is prevented in the drill mode. The handle housing forming a main handle of the hand-held machine tool is substantially completely decoupled from the main housing at all times so that virtually no vibrations can be transmitted from the main housing to the main handle.

The adjusting device on the handle housing side is preferably formed by a locking device of the locking arrangement which is displaceable between a releasing position and a locking position in which the pawl can be fixed in an engaged position of the motor switch by locking means. In this manner, a stable locking of the switch pawl can be ensured in chisel mode, and a reliable disabling of the locking means can be ensured in drill mode.

The locking arrangement advantageously has an activation member which is movable between an active position and a passive position by the adjusting connection. Further, the locking device has a locking switch by means of which the locking means can be moved in the active position of the activation member. In the passive position of the activation member, however, the adjusting function of the locking switch is canceled relative to the locking means. In this manner, the adjusting arrangement can reliably prevent locking in the drill mode and only enables locking in the chisel mode. The actual activation is carried out selectively by a user by actuating the locking switch. This enables a fast locking or release of the switch pawl in chisel mode for adapting to the respective circumstances.

In this connection, it is particularly advantageous when the activation member is biased in the passive position. In this way, it is ensured at all times that locking in drill mode is prevented even in the event of damage to the adjusting arrangement, for example, in the event that the flexible vibration-reducing portion tears.

The adjusting device on the main housing side is advantageously formed by a mode switch for switching between drill mode and chisel mode so that, when the desired operating mode is set, locking is also blocked simultaneously in the drill mode and locking is enabled or activated in the chisel mode.

In this connection, it is advantageous when the mode switch is coupled with an end of the adjusting connection on the main housing side so as to ensure a stable and precise actuation of the adjusting arrangement.

The invention is described in more detail in the following with reference to an embodiment example.

### BRIEF DESCRIPTION OF THE DRAWINGS

The drawings show:

FIG. 1 a plan view of an adjusting arrangement of a hand-held machine tool according to the invention in chisel mode and with a locking device in the locked position;

FIG. 2 a plan view of the adjusting arrangement according to FIG. 1 in chisel mode and with the locking device in the releasing position; and

FIG. 3 a plan view of the adjusting device according to FIG. 1 in hammer drill mode.

To facilitate understanding of the invention, identical reference numerals have been used, when appropriate, to designate the same or similar elements that are common to the figures. Further, unless stated otherwise, the drawings shown and discussed in the figures are not drawn to scale, but are shown for illustrative purposes only.

### DETAILED DESCRIPTION OF THE PREFERRED EMBODIMENTS

The invention is directed to a hand-held machine tool, particularly in the form of an electric multipurpose hammer which can be used selectively as a drill hammer or chisel hammer, having a main housing at which vibrations are generated during operation. In addition, the hand-held machine tool has a handle housing that is held at the main housing with the intermediary of a vibration-reducing device which damps the occurring vibrations or substantially insulates the handle housing from the vibrations occurring at the main housing.

In one embodiment, there is an adjusting arrangement which has a first adjusting device on the main housing side which can be adjusted between at least two positions. The adjusting arrangement further includes a second adjusting device provided on the handle housing side which can be adjusted between at least two positions and which is mechanically connected to the first adjusting device on the main housing side by an adjusting connection.

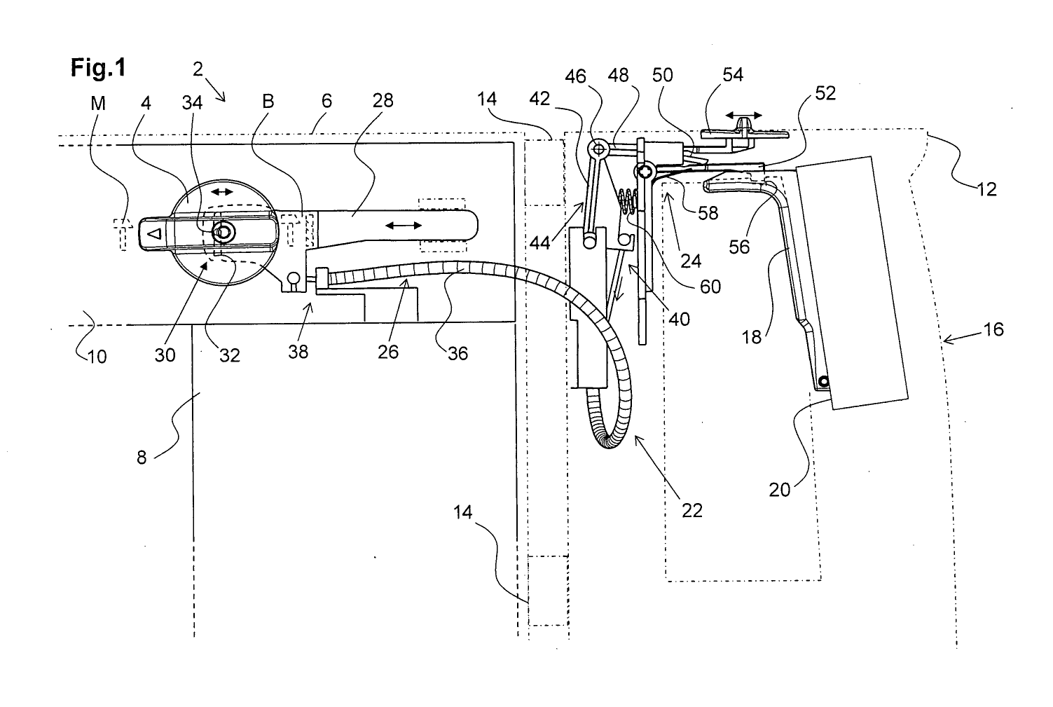

Referring to FIG. 1, a sectional view of a hand-held machine tool 2 in the form of an electrically operated multipurpose hammer is illustratively shown. As is indicated by a chisel position M and a drill position B, this hand-held machine tool 2 can be switched by a mode switch 4 between a chisel mode with purely percussive operation and a drill mode for either hammer drilling or simple drilling without the hammer function.

The hand-held machine tool 2 has a main housing 6 in which a motor unit 8 and a gear unit 10 are accommodated. Further, a handle housing 12 is held at the main housing 6 with the intermediary of a vibration-reducing portion 14 which has, for example, spring means, not shown in more detail. The handle housing 12 forms a handle 16 which can be held in the hand of a user and by which a pawl 18 of a motor switch 20 can be actuated at the same time in order to put the motor unit 8 and the entire hand-held machine tool 2 in operation.

During operation, vibrations occur at the main housing 6. The vibration-reducing portion 14 substantially prevents the transmission of vibrations from the main housing 6 to the handle housing 12.

In addition to switching between the operating modes, the mode switch 4 also functions as a main housing-side adjusting device of an adjusting arrangement, designated in its entirety by 22, between the main housing 6 and the handle housing 12. Further, this adjusting arrangement 22 has an adjusting device at the handle housing 12 which is formed on the handle housing side by a locking device 24. The locking device 24 is connected to the mode switch 4 by an adjusting connection 26 and can be switched between a locking position and a releasing position by this mode switch 4.

For this purpose, the adjusting connection 26 has a slide element 28 which is held so as to be displaceable in the main housing 6 and which is coupled with the mode switch 4 by a driver arrangement 30 having a slotted member 32 on the slide side and an eccentric cam 34 on the switch side. Further, the adjusting connection 26 has a flexible vibration-reducing portion 36 in the form of a bowden cable which is connected to the slide element 28 at an end 38 on the main housing side.

The flexible vibration-reducing portion 36 is connected to a first leg 42 of an activation member 44 at the end 40 on the handle housing side. This first leg 42 has a first end that is swivelably mounted at the handle housing 12, and a second opposing end that is connected to a second leg 48 of the activation member 44 by a rotary joint 46. Further, the second leg 48 is connected to an actuation tongue 50, which can engage at a locking hook 52 that is swivelably mounted in the handle housing 12.

In the position of the adjusting arrangement 22 functioning as a locking arrangement shown in FIG. 1, the locking device 24 is moved into an active position by the mode switch 4, which is set to chisel mode M, and by the adjusting connection 26 which applies a tractive force to the first leg 42. In this active position, the actuation tongue 50 is swivelable into a forward position (as is shown) against the locking hook 52 by displacing a locking switch 54. As a result, the adjusting arrangement 22 is in a locking position in which the locking hook 52 engages in a locking recess 56 of the pawl 18 which is accordingly held in an engaged position in which the motor switch 20 activates the motor unit 8.

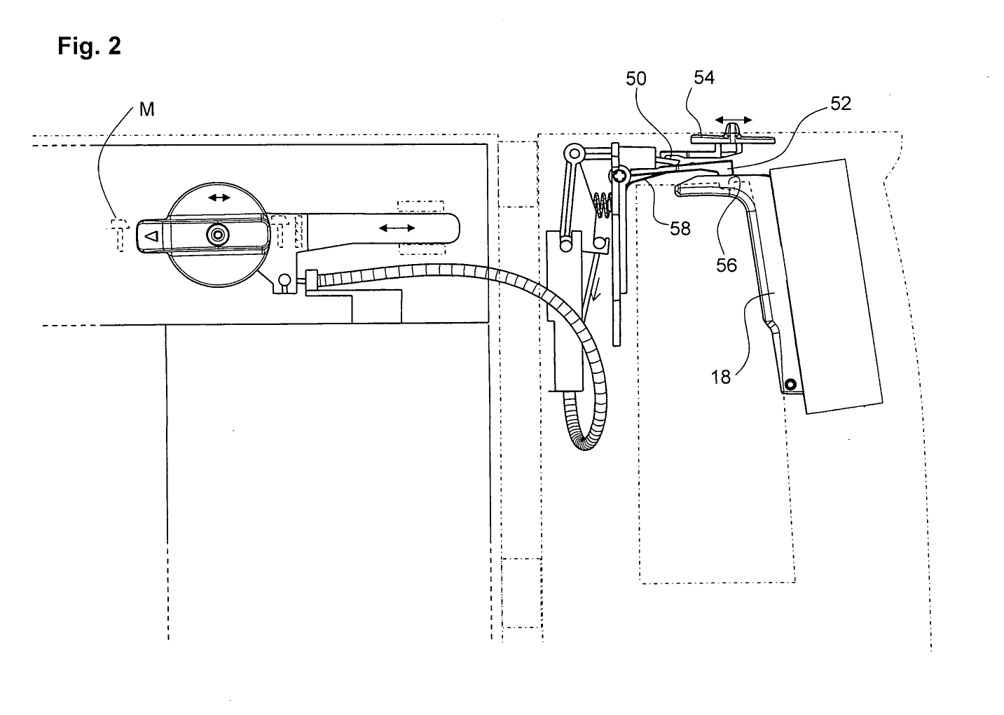

In order to disengage the locking position, the locking switch 54 is displaced into a rear position as is shown in FIG. 2. As a result, the actuation tongue 50 is no longer pressed against the locking hook 52 which is now swiveled out of engagement with the locking recess 56 by a leaf spring 58. The hand-held machine tool 2 can accordingly be operated in chisel mode optionally also without locking the pawl 18.

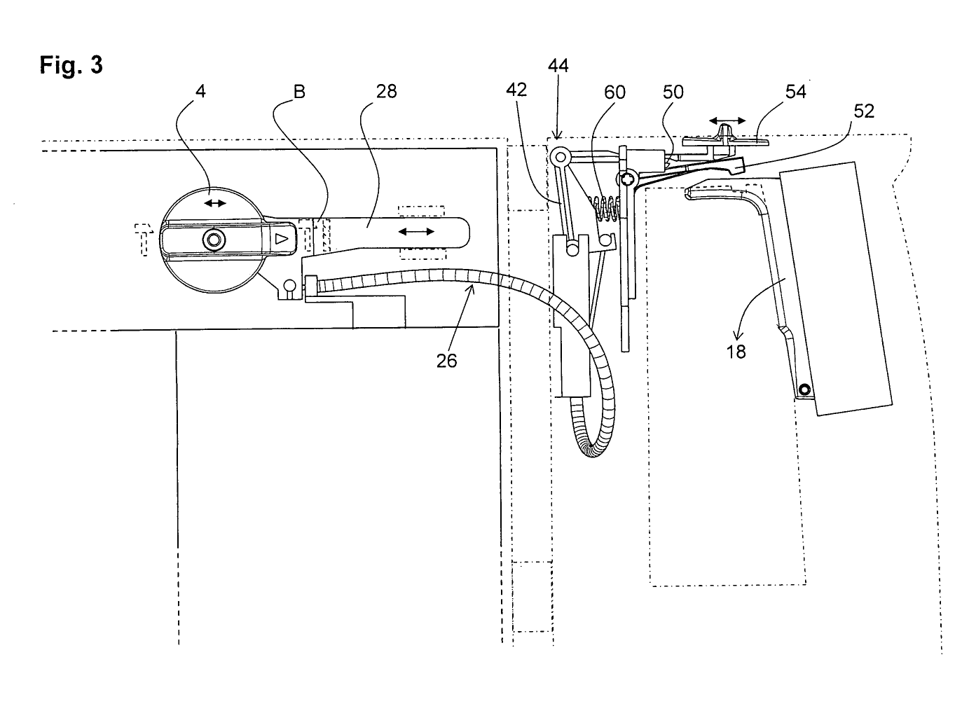

To switch to drill mode, the mode switch 4 is rotated into the drill position B referring to FIG. 3. The slide element 28 is displaced into a new position at the same time by the driver arrangement 30 so that the tractive force acting on the first leg 42 of the activation member 44 by the adjusting connection 22 is reduced. Accordingly, the first leg 42 which is acted upon by the biasing spring 60 is swiveled in direction away from the pawl 18. The activation member 44 then occupies the passive position shown in FIG. 3.

In this passive position, the actuation tongue 50 is positioned relative to the locking hook 52 in such a way that a displacement of the locking switch 54 cannot cause an engagement of the locking hook 52 with the locking recess 56. Therefore, it is ensured that in drill mode the locking device 24 is in a releasing position in which the pawl 18 cannot be locked.

In order to switch the hand-held machine tool 2 back to the chisel mode, the mode switch 4 is rotated into the chisel position M again and, by means of the slide element 28 and the flexible vibration-reducing portion 36, a tractive force again acts on the first leg 42 and moves the activation member 44 back into the active position shown in FIG. 1 in which a selected working position of the locking device 24 can be occupied by displacing the locking switch 54.

In hand-held machine tools of the present invention, the vibrations occurring at the handle housing during operation are sharply reduced relative to the vibrations at the main housing. Accordingly, the device can be held with a high degree of comfort. Further, the adjusting arrangement makes it possible to adjust an adjusting device constructed as a function device at the main housing or handle housing by means of an adjusting device constructed as a handling device which is held at the other respective housing part. In this manner, a stable locking of the switch pawl can be ensured in chisel mode, and a reliable disabling of the locking means can be ensured in drill mode.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held machine tool (2) with a main housing (6) at which vibrations are generated during operation, a handle housing (12) that is held at the main housing (6) with the intermediary of a vibration-reducing device (14), and an adjusting arrangement (22) which has an adjusting device on the main housing side which can be adjusted between at least two positions and an adjusting device on the handle housing side which can be adjusted between at least two positions and which is mechanically connected to the adjusting device on the main housing side by an adjusting connection (26), wherein the adjusting connection (26) has a flexible vibration-reducing portion (36) between the handle housing (12) and the main housing (6).

2. A hand-held machine tool according to claim 1, wherein the flexible vibration-reducing portion (36) is formed by a bowden cable.

3. A hand-held machine tool according to claim 1, wherein the hand-held machine tool (2) is an electric multipurpose hammer which can be switched between a drill mode and a chisel mode, and the adjusting arrangement (22) is formed by a locking arrangement which can be switched depending on function and by means of which a pawl (18) of a motor switch (20) can be fixed in position.

4. A hand-held machine tool according to claim 3, wherein the adjusting device on the handle housing side is formed by a locking device (24) of the locking arrangement which is displaceable between a releasing position and a locking position in which the pawl (18) can be fixed in an engaged position of the motor switch (20) by locking means.

5. A hand-held machine tool according to claim 4, wherein the locking arrangement has an activation member (44) which is movable between an active position and a passive position by the adjusting connection (26), and the locking device (24) has a locking switch (54) by means of which the locking means can be moved into the active position of the activation member (44) in the locking position and the locking switch (54) is prevented from acting on the locking means in the passive position of the activation member (44).

6. A hand-held machine tool according to claim 5, wherein the activation member (44) is biased in the passive position.

7. A hand-held machine tool according to one of claim 3, wherein the adjusting device on the main housing side is formed by a mode switch (4) for switching between drill mode and chisel mode.

8. A hand-held machine tool according to claim 7, wherein the mode switch (4) is coupled with an end (38) of the adjusting connection (26) on the main housing side.
